(19) United States
(12) Patent Application Publication
(10) Pub. No.: US 2025/0088972 A1
(43) Pub. Date: Mar. 13, 2025

(54) METHOD AND APPARATUS FOR CONTROLLING LINK IN WIRELESS COMMUNICATION SYSTEM

(71) Applicant: Electronics and Telecommunications Research Institute, Daejeon (KR)

(72) Inventors: Ji Hyung KIM, Daejeon (KR); Juho Park, Daejeon (KR); Jinkyu Kang, Daejeon (KR)

(73) Assignee: Electronics and Telecommunications Research Institute, Daejeon (KR)

(21) Appl. No.: 18/829,605

(22) Filed: Sep. 10, 2024

(30) Foreign Application Priority Data
Sep. 11, 2023 (KR) 10-2023-0120510
Sep. 3, 2024 (KR) 10-2024-0119061

(51) Int. Cl. H04W 52/14; H04B 7/04; H04L 1/1812; H04L 5/14; H04W 52/36; H04W 72/231

(52) U.S. Cl. CPC H04W 52/143; H04B 7/04013; H04L 1/1812; H04L 5/1469; H04W 52/367; H04W 72/231

(57) ABSTRACT

A method of a reflecting node may comprise: receiving, from a first node, power control information that sets an amplification amount of a first signal transmitted from the first node to a second node in an n-th slot, n being a natural number; amplifying the first signal received from the first node based on the power control information; and reflecting the amplified first signal to the second node, wherein the power control information includes information on a mode of a reflector included in the reflecting node, a maximum transmission power of the reflecting node, a signal power expected to be received at reflecting elements of the reflecting node, a first transmission gain function, and a first parameter set.

### CROSS-REFERENCE TO RELATED APPLICATIONS

This application claims priority to Korean Patent Applications No. 10-2023-0120510, filed on Sep. 11, 2023, and No. 10-2024-0119061, filed on Sep. 3, 2024, with the Korean Intellectual Property Office (KIPO), the entire contents of which are hereby incorporated by reference.

### BACKGROUND

### 1. Technical Field

The present disclosure relates to a wireless communication technique, and more particularly, to a technique for controlling links in a wireless communication system.

### 2. Related Art

In order to meet the increasing demand for wireless data traffic following the commercialization of 4G communication systems, efforts are being made to develop enhanced 5G communication systems or pre-5G communication systems. For this reason, the 5G communication systems or pre-5G communication systems are referred to as beyond-4G network communication systems or Post LTE systems. To achieve higher data transmission rates, the 5G communication systems are being considered for implementation in millimeter-wave (mmWave) bands, such as a 60 GHz band. To mitigate a path loss and increase a transmission distance of radio waves in the millimeter-wave band, techniques such as beamforming, massive MIMO, full dimensional MIMO (FD-MIMO), array antennas, analog beam-forming, and large scale antenna systems are being discussed in the 5G communication systems. In addition, to enhance the network of the system, the 5G communication systems are focusing on the development of technologies such as evolved small cells, advanced small cells, cloud radio access networks (cloud RAN), ultra-dense networks, Device-to-Device (D2D) communication, wireless backhaul, moving networks, cooperative communication, coordinated multi-points (COMP), and interference cancellation.

In addition, the 5G system is developing advanced coding and modulation techniques such as hybrid FSK and QAM modulation (FQAM) and sliding window superposition coding (SWSC), as well as advanced access technologies like filter bank multi carrier (FBMC), non-orthogonal multiple access (NOMA), and sparse code multiple access (SCMA).

Meanwhile, the Internet is evolving from a human-centered network, where humans generate and consume information, into an Internet of Things (IoT) network, where information is transmitted and processed among distributed components such as objects. The Internet of Everything (IoE) technology, which combines IoT with big data processing through connections with cloud servers and other infrastructures, is also emerging. To implement IoT, technological elements such as sensing technology, wired and wireless communication and network infrastructure, service interface technology, and security technology are required. Recently, technologies for connecting objects, such as sensor networks, machine-to-machine (M2M) communication, and machine type communication (MTC), are being researched. In the IoT environment, intelligent Internet Technology (IT) services can be provided by collecting and analyzing data generated from connected objects, thereby creating new value in human life. The IoT can be applied to various fields such as smart homes, smart buildings, smart cities, smart cars or connected cars, smart grids, healthcare, smart appliances, and advanced medical services through the convergence and integration of existing Information Technology (IT) with various industries.

In this context, various attempts are being made to apply 5G communication systems to IoT networks. For example, technologies such as sensor networks, M2M communication, and MTC are being implemented in 5G communication systems through techniques like beamforming, MIMO, and array antennas. The application of cloud radio access networks (cloud RAN) for big data processing, as mentioned earlier, can also be considered an example of the convergence between 5G technology and IoT technology.

### SUMMARY

The present disclosure for resolving the above-described problems is directed to providing a method and an apparatus for controlling a transmission power of a repeater (e.g. reflecting node or reconfigurable intelligent surface (RIS)) in a wireless communication system.

A method of a reflecting node, according to an exemplary embodiment of the present disclosure for achieving the above-described objective, may comprise: receiving, from a first node, power control information that sets an amplification amount of a first signal transmitted from the first node to a second node in an n-th slot, n being a natural number; amplifying the first signal received from the first node based on the power control information; and reflecting the amplified first signal to the second node, wherein the power control information includes information on a mode of a reflector included in the reflecting node, a maximum transmission power of the reflecting node, a signal power expected to be received at reflecting elements of the reflecting node, a first transmission gain function, and a first parameter set.

The first parameter set may include at least one of: a number of physical resource blocks (PRBs) in which the first signal is transmitted, subcarrier spacing (SCS) information, interference information measured by the first node, or a power offset according to a modulation and coding scheme (MCS) of the first signal.

When the first node is a base station, the second node is a user equipment (UE), and the first node and the reflecting node are wirelessly connected, the power control information may be transmitted through a physical downlink control channel (PDCCH) or high layer signaling.

The first transmission gain function may be determined based on a sum of a first transmission gain value determined by multiplying a second transmission gain state function value determined in an (n−1)-th slot with a weight factor received from the first node and a correction value received from the first node.

When the first signal is an initial transmission signal, the weight factor may have a zero value.

When a time division duplex (TDD) configuration is used between the first node and the second node, the first transmission gain function may be configured for each of a power gain from the first node to the second node and a power gain from the second node to the first node.

The first transmission gain function may vary depending on a phase shift design, and one or more transmission gain functions may be available for one phase shift design.

The first transmission gain function may be configured for at least one of each reflecting element included in the reflecting node, each of cluster(s) composed of multiple reflecting elements, or all of the reflecting elements of the reflecting node, and the cluster(s) may be configured in advance by the first node.

A method of a base station, according to an exemplary embodiment of the present disclosure for achieving the above-described objective, may comprise: transmitting, to a reflecting node, power control information that sets an amplification amount of a first signal to be transmitted to a terminal in an n-th slot, n being a natural number; and transmitting the first signal to the reflecting node at a preset power, wherein the power control information includes information on a mode of a reflector included in the reflecting node, a maximum transmission power of the reflecting node, a signal power expected to be received at reflecting elements of the reflecting node, a first transmission gain function, and a first parameter set.

The first parameter set may include at least one of: a number of physical resource blocks (PRBs) in which the first signal is transmitted, subcarrier spacing (SCS) information, interference information measured by the first node, or a power offset according to a modulation and coding scheme (MCS) of the first signal.

The first transmission gain function may be determined based on a sum of a first transmission gain value determined by multiplying a second transmission gain state function value determined in an (n−1)-th slot with a weight factor received from the first node and a correction value received from the first node.

When the first signal is an initial transmission signal, the weight factor may have a zero value.

When a time division duplex (TDD) configuration is used between the first node and the second node, the first transmission gain function may be configured for each of an uplink power gain and a downlink power gain.

The first transmission gain function mat vary depending on a phase shift design, and one or more transmission gain functions may be available for one phase shift design.

The first transmission gain function may be configured for at least one of each reflecting element included in the reflecting node, each of cluster(s) composed of multiple reflecting elements, or all of the reflecting elements of the reflecting node, and the cluster(s) may be configured in advance by the first node.

A reflecting node, according to an exemplary embodiment of the present disclosure for achieving the above-described objective, may comprise: a reconfigurable intelligent surface (RIS) reflector including a plurality of reflecting elements; and at least one processor for controlling the RIS reflector, wherein at least one processor may cause the reflecting node to perform: receiving, from a first node, power control information that sets an amplification amount of a first signal transmitted from the first node to a second node in an n-th slot, n being a natural number; amplifying the first signal received from the first node based on the power control information; and reflecting the amplified first signal to the second node, wherein the power control information includes information on a mode of a reflector included in the reflecting node, a maximum transmission power of the reflecting node, a signal power expected to be received at reflecting elements of the reflecting node, a first transmission gain function, and a first parameter set.

The first parameter set may include at least one of: a number of physical resource blocks (PRBs) in which the first signal is transmitted, subcarrier spacing (SCS) information, interference information measured by the first node, or a power offset according to a modulation and coding scheme (MCS) of the first signal.

When the first node is a base station, the second node is a user equipment (UE), and the first node and the reflecting node are wirelessly connected, the power control information may be transmitted through a physical downlink control channel (PDCCH) or high layer signaling.

The first transmission gain function may be determined based on a sum of a first transmission gain value determined by multiplying a second transmission gain state function value determined in an (n−1)-th slot with a weight factor received from the first node and a correction value received from the first node, and when the first signal is an initial transmission signal, the weight factor may have a zero value.

The first transmission gain function may vary depending on a phase shift design, and one or more transmission gain functions may be available for one phase shift design.

According to the exemplary embodiments of the present disclosure, in a wireless communication system using a high-frequency band, an RIS node for reflecting signals can convert a received signal to have a desired power level and phase by amplifying and/or altering a phase of the received signal, and then transmit it to a destination. Specifically, the RIS node can determine a transmission gain according to each situation and may also determine the transmission gain for each range of reflecting elements. Through this, the RIS node can determine a signal transmission gain according to the situation. Furthermore, by appropriately controlling the reflecting elements that constitute the RIS reflector, the RIS node can achieve optimal efficiency. Additionally, a node that controls the RIS node has the advantage of being able to appropriately manage the overhead of control information used to control a reflection gain.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a structure of a time-frequency region, which is a radio resource region of the 5G communication system.

FIG. 4 is a conceptual diagram illustrating a structure of one RB configured as one slot in the 5G communication system.

FIG. 5 is a conceptual diagram for describing a case where a base station communicates with a terminal by controlling power amplification of an RIS node.

FIG. 6 is a transmission power graph according to an exemplary embodiment of a case where an RIS node transmits a received signal by amplifying the signal.

FIG. 7 is a transmission power graph according to another exemplary embodiment of a case where an RIS node transmits a received signal by amplifying the signal.

FIG. 8 is a conceptual diagram for describing a case where multiple base stations transmit signals to terminals through one RIS node.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like. Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

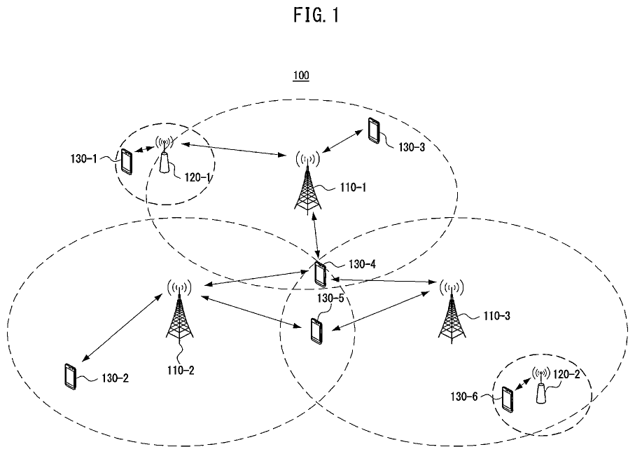

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

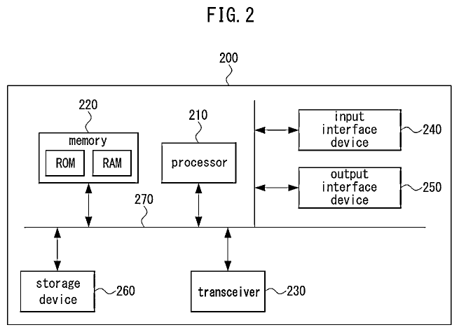

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Meanwhile, wireless communication systems are evolving from providing voice-oriented services in the early days to providing high-speed, high-quality packet data services, as broadband wireless communication systems. Technologies that provide high-speed and high-quality packet data services include, for example, 3GPP's High Speed Packet Access (HSPA), Long Term Evolution (LTE) or Evolved Universal Terrestrial Radio Access (E-UTRA), LTE-Advanced (LTE-A), LTE-Pro, 3GPP2's High Rate Packet Data (HRPD), Ultra Mobile Broadband (UMB), and IEEE's 802.16e.

The LTE system, a representative example of a broadband wireless communication system, adopts an orthogonal frequency division multiplexing multiple access (OFDMA) scheme in downlink (DL) and a single carrier frequency division multiple access (SC-FDMA) scheme in uplink (UL). Uplink (UL) refers to a wireless link in which a terminal, for example, a user equipment (UE) or a mobile station (MS), transmits data or a control signal to a base station, for example, an eNode B (eNB) or a base station (BS). Downlink (DL) refers to a wireless link in which a base station transmits data or a control signal to a terminal. In addition, the multiple access schemes mentioned above can distinguish the data or control information of each user by allocating and managing resources in such a way that the time-frequency resources used for transmitting data or control information to respective users do not overlap. In other words, this ensures that orthogonality is maintained.

The 5G communication system, which is a wireless communication system after LTE, needs to support services that simultaneously satisfy various requirements so that various requirements of users and service providers can be freely reflected. The services being considered for the 5G communication systems include enhanced mobile broadband (eMBB), massive machine type communication (mMTC), and ultra reliability low latency communication (URLLC).

The eMBB aims to deliver a data transmission rate higher than that supported by existing LTE, LTE-A, or LTE-Pro. For instance, in the 5G communication system, eMBB should achieve a peak data rate of 20 Gbps downlink and 10 Gbps uplink from the perspective of a single base station. Furthermore, the 5G communication system should enhance the user-perceived data rate while delivering peak data rates. To meet these requirements, advancements in various transmission/reception technologies, including improved multi-input multi-output (MIMO) transmission technology, may be necessary. Additionally, while the LTE system transmits signals using a maximum bandwidth of 20 MHz in the 2 GHz band, the 5G communication system can meet the required data transmission rates by utilizing a frequency bandwidth wider than 20 MHz in the 3 to 6 GHz range or higher.

When a base station supports a wide bandwidth frequency, the technology of dividing the entire carrier frequency band into several frequency bandwidth parts (BWPs) that each terminal can support is becoming increasingly important. For instance, if a terminal has a limited bandwidth (BW) capability, a base station supporting BWPs can allocate a smaller frequency band to the terminal based on its BW capability. Additionally, the base station can reduce the terminal's energy consumption by switching BWPs to reduce the frequency band during communication. Furthermore, the base station can support a different frame structure for each BWP. By supporting a different frame structure for each BWP, the base station can seamlessly provide various services to a single terminal by switching between BWPs without incurring latency. In the above-described manner, the BWP technology may be applied to control channels or data channels that correspond one-to-one between a specific terminal and the base station. In addition, when the base station separately configures a BWP for transmitting a common signal transmitted to multiple terminals in the system and a BWP for transmitting data, the energy of the base station can be reduced. The common signals transmitted to multiple terminals may include, for example, a synchronization signal, a physical broadcast channel (PBCH), system information (SI), and the like.

In the 5G communication system, mMTC is being considered to support application services such as the Internet of Things (IoT). To efficiently enable IoT, mMTC should support large-scale terminal connections within a cell, improved terminal coverage, extended battery life, and reduced terminal costs. Since IoT relies on attaching various sensors to different communication devices, it needs to support a vast number of terminals (e.g. 1,000,000 terminals/km²) within a single cell. Additionally, due to the nature of the service, terminals supporting mMTC are likely to be located in areas with poor coverage, such as building basements, and therefore require wider coverage than other services provided by the 5G communication system. These terminals need to be low-cost and, given the difficulty of frequently replacing their batteries, require very long battery lifetimes, for example, 10 to 15 years.

Finally, URLLC is a cellular-based wireless communication service designed for mission-critical purposes. For example, it may be considered for services such as remote control of robots or machinery, industrial automation, unmanned aerial vehicles, remote healthcare, emergency alerts, and similar applications. As a result, communications provided by URLLC should offer extremely low latency and exceptionally high reliability. For instance, services supporting URLLC should meet an air interface latency of less than 0.5 milliseconds while also satisfying a packet error rate of less than 10-5. To achieve these requirements, the 5G system needs to provide a shorter transmit time interval (TTI) for services supporting URLLC compared to other services, and simultaneously allocate wider frequency band resources to ensure the reliability of communication links.

The three services of the 5G communication system (hereinafter referred to interchangeably as ‘5G system’)—eMBB, URLLC, and mMTC—may be multiplexed and transmitted within a single system. In this context, different transmission and reception techniques, as well as transmission and reception parameters, may be employed between services to meet their distinct requirements.

Hereinafter, a frame structure of the 5G communication system will be described below with reference to the attached drawing.

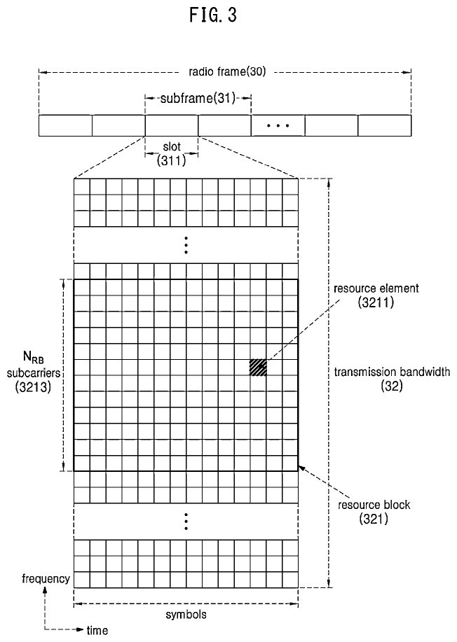

FIG. 3 is a conceptual diagram illustrating a structure of a time-frequency region, which is a radio resource region of the 5G communication system.

Referring to FIG. 3, the horizontal axis may represent the time domain, and the vertical axis may represent the frequency domain. A radio frame 30 may have a fixed time length of 10 ms and may be composed of 10 subframes each having a time length of 1 ms. One subframe 31 may be composed of one or more slots. Whether one subframe 31 is composed of one slot or two or more slots may vary depending on a numerology, that is, a subcarrier spacing (SCS). In the 5G communication system, 15 kHz, 30 kHz, 60 kHz, 120 kHz, 240 kHz, etc. may be used as the SCS. An example of a case where one subframe 31 is composed of one or more slots depending on the SCS is as follows. When the SCS is 15 kHz, one subframe may consist of one slot, when the SCS is 30 kHz, one subframe may consist of two slots, when the SCS is 60 kHz, one subframe may consist of four slots, and when the SCS is 120 kHz, one subframe may consist of eight slots. In FIG. 3, since one subframe 31 is composed of two slots, it may correspond to the case that the SCS is 30 KHz.

The one slot 311 may be composed of 14 consecutive OFDM symbols in the time domain. Alternatively, the one slot 311 may be composed of 14 consecutive discrete Fourier transform spread OFDM (DFT-s-OFDM) symbols in the time domain. In the following description, for convenience of description, it is assumed that 14 consecutive OFDM symbols are used along the time axis of the slot.

The one slot 311 illustrated in FIG. 3 may be composed of resource elements (REs) 3211, each consisting of one OFDM symbol and one subcarrier. In the 5G communication system, a resource allocation unit may be a resource block (RB) 321. An RB in the 5G communication system is defined as 12 consecutive REs in the frequency domain. Notably, the RB is defined only in the frequency domain and not in the time domain. The reason for not defining a time domain unit for the RB in the 5G communication system is to allow for flexible scheduling, which is necessary to accommodate various services (e.g. eMBB, mMTC, URLLC) as described above.

A transmission bandwidth 32 illustrated in FIG. 3 may be a bandwidth of a BWP configured for communication with a specific terminal. As another example, the transmission bandwidth 32 illustrated in FIG. 3 may be the entire bandwidth that the base station can use. The transmission bandwidth 32 may be composed of N_{BW} subcarriers. In addition, one RB 321 may be composed of N_{RB} consecutive subcarriers 3213. Therefore, N_{RB} may be 12.

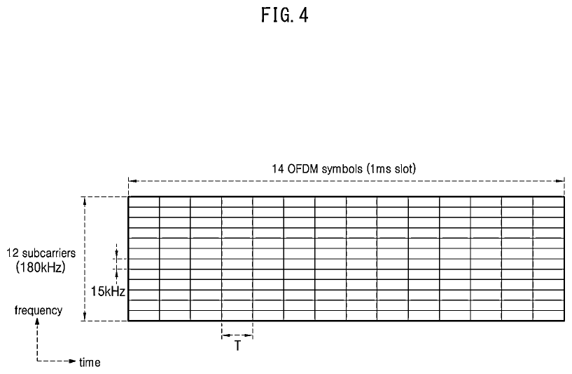

FIG. 4 is a conceptual diagram illustrating a structure of one RB configured as one slot in the 5G communication system.

Referring to FIG. 4, as described above, the horizontal axis may represent the time domain, and the vertical axis may represent the frequency domain. According to the example of FIG. 4, a structure of one RB composed of 12 subcarriers within one slot composed of 14 OFDM symbols is illustrated. In FIG. 4, one subcarrier is illustrated as having a width of 15 kHz. In other words, the SCS may be 15 kHz. Therefore, a bandwidth of the entire subcarriers constituting the RB may be 180 kHz. When the SCS is 15 kHz, one slot may have a period of 1 ms. In FIG. 4, a transmission time interval of one symbol is denoted as T.

Based on FIGS. 3 and 4 described above, the number N_{symb}^{slot} of OFDM symbols within a slot for each SCS, the number Nₛₗₒₜ^{frame,μ} of slots included within one radio frame for each SCS, and the number Nₛₗₒₜ^{subframe,μ} of slots within a subframe for each SCS may be exemplified as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In Table 1 above, the case where μ is 0 may correspond to the case where the SCS is 15 kHz, the case where μ is 1 may correspond to the case where the SCS is 30 kHz, the case where μ is 2 may correspond to the case where the SCS is 60 kHz, the case where μ is 3 may correspond to the case where the SCS is 120 kHz, the case where μ is 4 may correspond to the case where the SCS is 240 kHz, and the case where μ is 5 may correspond to the case where the SCS is 480 KHz.

As exemplified in Table 1 above, when μ is 0 and the SCS is 15 kHz, the number of slots within a radio frame is 10, and one subframe may be composed of one slot. When μ is 1 and the SCS is 30 kHz, the number of slots within a radio frame is 20, and one subframe may be composed of two slots. In the same manner, when μ is 5 and the SCS is 480 kHz, the number of slots within a radio frame is 320, and one subframe may be composed of 32 slots.

Meanwhile, since the 5G communication system transmits and receives signals (or data) through a wireless channel between a base station and a terminal, determining a transmission power for transmitting data may be a very important factor. Hereinafter, methods for determining a transmission power of a signal (or data) transmitted in the 5G communication system will be described. In particular, methods for determining a transmission power when a terminal transmits data through an uplink channel will be described below.

If the terminal transmits uplink data with an insufficient transmission power, the base station may not receive the data transmitted by the terminal, or may fail to demodulate and/or decode the data transmitted by the terminal even if it receives the data transmitted by the terminal. On the other hand, if the terminal transmits uplink data with an excessive transmission power, interference may occur with other signals, for example, transmission signals and/or reception signals of adjacent terminals.

To solve the problem described above, in the 5G communication system, the terminal may determine a transmission power of data to be transmitted in uplink based on a path loss and a power control command received from the base station. The path loss may be determined based on a specific reference signal (RS) received by the terminal from the base station. For example, a synchronization signal block (SSB) may be used as one type of RS, or a channel state information-reference signal (CSI-RS) may be used. When the terminal calculates the path loss using SSB(s), the terminal may calculate the path loss by receiving SSB(s) broadcast by the base station and measuring a reception power of the received SSB(s). A method of determining a transmission power of data to be transmitted in uplink based on the path loss and the power control command received from the base station will be described in more detail below.

The terminal may transmit data to the base station on a physical uplink shared channel (PUSCH). In this case, when the terminal transmits data to the base station on a PUSCH, a transmission power P may be determined as in Equation 1 below.

$${P}_{PUSCH , f , c} ( i , j , {q}_{d} , l ) = min \{ \begin{matrix}{P}_{CMAX , f , c} ( i ) , \\ 10 {log}_{10} ( {2}^{μ} \cdot {M}_{RB , f , c}^{PUSCH} ( i ) ) + {P}_{{O}_{PUSCH} , f , c} ( j ) + \\ {α}_{f , c} ( j ) \cdot {PL}_{f , c} ( {q}_{d} ) + {Δ}_{TF , f , c , n} ( i ) + {f}_{f , c} ( i , l )\end{matrix} \} \qquad [ Equation 1 ]$$

A value determined by Equation 1 may be in dBm unit. In addition, P_{PUSCH,f,c} in Equation 1 may mean that the transmission power of the PUSCH is defined for each cell c and each carrier frequency f. In Equation 1, a parameter i for determining P_{PUSCH,f,c} may be an index of a slot in which data is transmitted through the PUSCH, j is may be a parameter set configuration index configured by the base station, q_{d} may refer to a resource used to calculate the path loss, and l may refer to a power control state function index. Here, q_{d} meaning the resource used to calculate the path loss may indicate a signal that can be used as the RS as described above. For example, q_{d} may indicate only SSB, only CSI-RS, or both SSB and CSI-RS.

Therefore, Equation 1 may mean that the transmission power for the terminal to transmit data through the PUSCH may be determined as a smaller value among the maximum transmission power P_{CMAX,f,c} (i) allowed to the terminal and a value calculated by a calculation formula. The maximum transmission power allowed to the terminal may be determined by a power class of the terminal and a configuration of high layer signaling received from the base station.

The parameters of Equation 1 are as follows.

In Equation 1, α_{f,c}(j) is a value set to partially compensate for the path loss between the base station and the terminal, and may be set to a value greater than 0 and less than or equal to 1. In Equation 1, PL_{f,c}(q_{d}) may be the path loss between the base station and the terminal, and may be a value calculated based on a difference between a transmission power of the RS, which is signaled by the base station to the terminal, and a reception power of the RS received by the terminal, as described above. If q_{d} indicates only SSB, PL_{f,c}(qₐ) may be calculated from a difference between a transmission power of the SSB, which is signaled by the base station, and a reception power of the SSB received by the terminal. As another example, if qₐ indicates only CSI-RS, PL_{f,c} (qₐ) may be calculated from a difference between a transmission power of the CSI-RS, which is signaled by the base station, and a reception power of the CSI-RS received by the terminal. As another example, if q_{d} indicates both SSB and CSI-RS, PL_{f,c}(q_{d}) may be calculated using a difference between a transmission power of the SSB, which is signaled by the base station, and a reception power of the SSB received by the terminal and a difference between a transmission power of the CSI-RS, which is signaled by the base station, and a reception power of the CSI-RS received by the terminal. In Equation 1, f_{f,c} (i, l) is the l-th power control state function calculated according to a power control command included in the base station's scheduling information in the slot i, and the number of power control state functions may be set by the base station to the terminal through higher layer signaling.

Unexplained factors among the factors in Equation 1 may be factors included in a parameter set A configured by the base station and provided to the terminal. The parameter set A may include M_{RB,f,c,n}(i), P_{O}_{_{PUSCH}}_{,f,c} (j), and Δ_{TF,f,c,n}(i).

M_{RB,f,c,n}(i) included in the parameter set A may indicate the number of physical resource blocks (PRBs), which is the amount of frequency resources scheduled by the base station for the slot i. μ included in the parameter set A may have one of the values exemplified in Table 1 as an SCS configuration value as described above. P_{O}_{_{PUSCH}}_{,f,c}(j) included in the parameter set A may mean the amount of interference measured and signaled by the base station to the terminal. Finally, Δ_{TF,f,c,n}(i) included in the parameter set A may be a power offset according to a format or modulation and coding scheme (MCS) of data transmitted by the base station for the slot i.

Meanwhile, in the 5G communication systems, a millimeter wave (mmWave) band of 6 GHz or above may be used as a carrier frequency. When transmitting and receiving signals using the carrier frequency in the mmWave band, since attenuation of a propagation path increases, and refraction and diffraction hardly occur, a communication coverage may be limited. To solve such communication coverage problem, a method of installing a large number of base stations and/or densely distributing a large number of relays may be considered. However, if a large number of base stations are installed and/or a large number of relays are densely distributed, installation costs of the base stations and/or relays may significantly increase, and costs of operating the base stations and/or relays may also significantly increase.

To solve such communication coverage problem, a method of using reconfigurable intelligent surfaces (RISs) instead of the base stations and/or relays may be considered. The RIS is a device having reflecting elements that can reflect a signal, and may be a node located between the base station and the terminal. In the case of downlink, the RIS node may receive a signal transmitted by the base station, phase-shift and/or amplify the signal, and reflect the signal transmitted by the base station toward the terminal. In addition, in the case of uplink, the RIS node may receive a signal transmitted by the terminal, phase-shift and/or amplify the signal, and reflect the signal transmitted by the terminal toward the base station. In this case, by optimizing the power amplification of the signal for downlink and uplink, unnecessary power consumption of the RIS node can be prevented, and interference in uplink and/or downlink can be minimized.

Hereinafter, the present disclosure will describe methods for controlling signal power amplification of the RIS node. The following description will be made assuming that the RIS node is controlled by a base station. However, the RIS node may be controlled in various ways. For instance, as described in the present disclosure, the RIS node may be controlled by a base station. In this context, the base station is described as including a core network. Additionally, when the base station comprises a central unit (CU) and a distributed unit (DU), it is described as including both. Therefore, the term ‘base station’ in the present disclosure may refer to a CU, a DU, or both. In another example, the RIS node may be controlled independently in a stand-alone manner. Alternatively, it may be controlled by a terminal, such as a UE, or by another RIS node.

In the present disclosure described below, an entity responsible for power amplification control of the RIS node may be understood to be replaced by a base station, a UE, the RIS node itself, or another RIS node. If the base station is understood to refer to another node, the subsequent description may be applied as is or interpreted in a similar manner. However, for convenience of description, the following description assumes that the base station controls the power amplification of the RIS node.

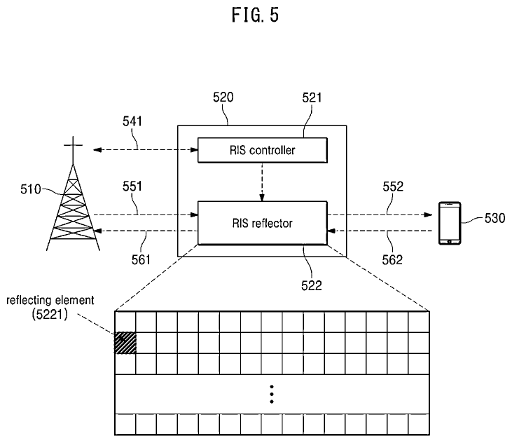

FIG. 5 is a conceptual diagram for describing a case where a base station communicates with a terminal by controlling power amplification of an RIS node.

Referring to FIG. 5, an RIS node 520 may be located between a base station 510 and a terminal 530. The RIS node 520 may amplify a signal transmitted by the base station 510 and transmit it to the terminal 530 when the signal transmitted by the base station 510 is not delivered to the terminal 530 due to an obstacle between the base station 510 and the terminal 530 or when the signal transmitted by the base station 510 is not delivered to the terminal 530 due to serious attenuation.

The RIS node 520 may be composed of an RIS controller 521 and an RIS reflector 522. The RIS controller 521 may be connected to the base station 510 in a wired or wireless manner. The RIS controller 521 may receive control information from the base station 510 and perform power amplification and/or phase shift on the RIS reflector 522 based on the received control information. The RIS controller 521 may be implemented with one or more processors.

In the case where the RIS node 520 is controlled by the base station 510 and there is a wireless connection between the RIS node 520 and the base station 510, the RIS node 520 may further include a separate device for transmitting and receiving signals. As another example, in the case where the RIS node 520 is controlled by the base station 510 and there is a wireless connection between the RIS node 520 and the base station 510, a signal for RIS control may be obtained from among signals received through the RIS reflector 522.

In the case where the RIS node 520 is controlled by the base station 510 and the RIS node 520 and the base station 510 are connected by a wire, the RIS node 520 may further include a separate interface device for transmitting and receiving signals.

The RIS reflector 522 may amplify and phase-shift the signal based on the control of the RIS controller 521 and then transmit it to the destination. In the case of downlink transmission, the base station 510 may transmit a signal to be transmitted to the terminal 530 to the RIS reflector 522 through a downlink channel 551. The downlink channel 551 may carry a broadcast channel for information that all terminals need to receive, such as SSB and various types of system information (SI), a physical downlink control channel (PDCCH) for control information, and a physical downlink shared channel (PDSCH) for data.

The RIS reflector 522 may receive a signal transmitted from the base station 510 through the downlink channel 551. The RIS reflector 522 may amplify and/or phase-shift the signal received through the downlink channel 551 based on the control of the RIS controller 521. The signal that has been amplified and/or phase-shifted by the RIS reflector 522 may be transmitted to the terminal 530 through a downlink channel 552. In FIG. 5, different reference numerals are used for the downlink channel 551 between the base station 510 and the RIS node 520 and the downlink channel 552 between the RIS node 520 and the terminal 530. This is to indicate that the signal transmitted through the downlink channel 551 and the signal transmitted through the downlink channel 552 carry the same control information and/or data, but may have different power levels and phases.

In the case of uplink, the terminal 530 may transmit a signal to be transmitted to the base station 510 to the RIS reflector 522 through an uplink channel 562. The uplink channel 562 may carry a PUCCH and a PUSCH. The RIS reflector 522 may receive a signal transmitted from the terminal 530 through the uplink channel 562. The RIS reflector 522 may amplify and/or phase-shift the signal received through the uplink channel 562 based on the control of the RIS controller 521. The signal that has been amplified and/or phase-shifted by the RIS reflector 522 may be transmitted to the base station 510 through an uplink channel 561. The uplink channel 561 and the uplink channel 562 are distinguished in FIG. 5 to indicate that the signal transmitted through the uplink channel 561 and the signal transmitted through the uplink channel 562 carry the same control information and/or data, but their power levels and phases may be different.

Meanwhile, the RIS reflector 522 may be configured as a single panel form composed of a plurality of reflecting elements as illustrated in a lower part of FIG. 5. One reflecting element 5221 may be configured as an element capable of reflecting radio waves. In addition, one reflecting element 5221 may perform power amplification and/or phase shift on incident radio waves when reflecting the radio waves. The power amplification and/or phase shift on the incident radio waves may be performed under the control of the RIS controller 521. The power amplification and/or phase shift on the incident radio waves may be performed not by a single reflecting element but by a plurality of reflecting elements. The reflecting elements may be composed of various materials such as metamaterials and may be composed of a plurality of layers. In the present disclosure, no particular restrictions are placed on the material and configuration form constituting each of the reflecting elements.

The RIS reflector 522 may be configured to operate in one of the following three modes depending on a hardware design of the reflector.

First, reflecting elements 5221 constituting the RIS reflector 522 may be configured to operate in a mode in which they simply reflect signals without amplifying them. In other words, the RIS reflector 522 may be referred to as a ‘passive RIS reflector’ in the case where it has no transmission gain.

Second, the reflecting elements 5221 constituting the RIS reflector 522 may be configured to operate in a mode in which they can amplify and reflect signals. As described above, the RIS reflector 522 may amplify and reflect signals transmitted through a downlink channel and/or an uplink channel under the control of the RIS controller 521. In other words, the RIS reflector 522 may be referred to as an ‘active RIS reflector’ in the case where it has a transmission gain.

Third, the reflecting elements 5221 constituting the RIS reflector 522 may be configured to operate as either a passive RIS reflector or an active RIS reflector. For example, the RIS reflector 522 may be configured to operate as either a passive reflector or an active RIS reflector under the control of the RIS controller 511. In this case, when the RIS reflector 522 operates as either a passive reflector or an active RIS reflector, the RIS reflector may be referred to as a ‘hybrid RIS reflector’.

Hereinafter, various exemplary embodiments for power amplification control on incident radio waves (or channel or signal) using the RIS reflector 522 in the RIS node 520 will be described. By using at least one of power control schemes of the RIS node 520 according to the present disclosure below, it is possible to prevent unnecessary power consumption of other relay nodes or access points (APs) as well as power gain configuration of the RIS node 520. Accordingly, interference by the RIS node 520 can be reduced.

In the exemplary embodiment of FIG. 5 and description thereon, the RSI node 520 is exemplified only as operating under the control of the base station 510. However, the RIS node 520 may be controlled by another RIS node or may be controlled by the terminal 530. If the RIS node 520 is controlled by another RIS node, a connection between the RIS nodes may be a wired or wireless connection, like the connection between the base station 510 and the RIS node 520 described above. However, if the RIS node 520 is controlled by the terminal 530, only a wireless connection may be used between the RIS node 520 and the terminal 530.

The base station 510 illustrated in FIG. 5 may include all or at least some of the components illustrated in FIG. 2. In addition, the base station 510 may further include additional components as well as the components illustrated in FIG. 2. For example, in the case of a wired connection between the base station 510 and the RIS node 520, the base station 510 may further include an interface for transmitting control data between the base station 510 and the RIS node 520. In addition, the base station 510 may further include an interface for communicating with adjacent base stations and an interface for transmitting and receiving data and/or control information with higher nodes of the core network.

The terminal 530 may also include all or part of the components illustrated in FIG. 2. In addition, the terminal 530 may further include other components not illustrated in FIG. 2. For example, the terminal 530 may further include a user input interface and various sensors for convenience of the user. If the terminal 530 is an IoT device, the terminal 530 may not include the storage device 260 for low-power operations.

### First Exemplary Embodiment

In the first exemplary embodiment, methods of determining a power amplification value of a signal reflected by the RIS node 520 and transmitting the signal will be described for a case where the RIS node 520 receives a signal (or data) transmitted by the base station 510 or the terminal 530, and transmits the signal by phase-changing or amplifying the signal. In other words, when the RIS node 520 reflects incident radio waves, methods in which the RIS node 520 sets a transmission gain of the reflected radio waves will be described.

The power amplification value for the reflected signal of the RIS node 520 may be determined in a similar manner to the above-described method of determining a transmission power of the terminal. The amount of amplification applied to an incident signal reflected by the reflector when the RIS node 520 reflects the incident signal will be referred to as ‘RIS transmission power’ or ‘transmission gain’ for convenience of description.

When a power control state function index l of the RIS is used in the slot i and the RIS transmission power is denoted as P_{RIS}, the RIS transmission power P_{RIS} may be calculated as in Equation 2 below, and the RIS transmission power P_{RIS} may be expressed in dBm units. In addition, when the RIS node 520 supports multiple carrier frequencies in multiple cells, the RIS transmission power P_{RIS} may be determined for each cell parameter c and carrier frequency parameter f. In addition, when the RIS reflector 522 of the RIS node 520 is capable of determining a transmission power in units of n reflecting elements or n clusters, the corresponding reflecting elements or clusters may be distinguished by the index n. In addition, the k value may refer to the mode of the RIS reflector as mentioned above. For example, in the case of a passive RIS reflector, k may be set to 0, in the case of an active RIS reflector, k may be set to 1, and in the case of a hybrid reflector, k may be set to 2.

$${P}_{RIS , f , c , n} ( i , k , l ) = min \{ \begin{matrix}{P}_{MAX , f , c , n} ( i ) , \\ Parameter set A + Received {Power}_{n} ( i ) + {g}_{f , c , n} ( i , k , l )\end{matrix} \} \qquad [ Equation 2 ]$$

In Equation 2, P_{MAX,f,c,n}(i) is the maximum transmission power of the RIS node, which is allowed to the RIS node for the n-th reflecting element/cluster, may be configured based on a power class of the RIS node and higher layer signaling. If the RIS is controlled by the terminal 530, P_{MAX,f,c,n}(i) may be set by the terminal controlling the RIS node.

Equation 2 means that the smaller value among the maximum transmission power of the RIS or a value calculated by a calculation formula may be used as P_{RIS,f,c,n}(i, k, l). The parameters included in the calculation formula in Equation 2 will be described below.

In Equation 2, Received Powerₙ(i), which is a reception power parameter, may mean a power value of a signal received at the n-th reflecting element/cluster included in the RIS reflector 522 of the RIS node 520 or at the RIS node 520. If the RIS node 520 estimates a transmission power of the signal received at the n-th reflecting element, the reception power parameter Received Powerₙ(i) may be a reception power measured (or estimated) at the RIS reflector 522 of the RIS node 520. As another example, if the base station 510 controls the RIS node 520, the base station 510 may set the reception power expected at the RIS node 520 as Received Powerₙ(i) and transmit it to the RIS node 520. As another example, if the terminal controls the RIS node 520, the terminal may set the reception power expected at the RIS node 520 to Received Powerₙ(i) and transmitted to the RIS node (520).

In Equation 2, g_{f,c,n}(i, k, l) is a transmission gain function of the RIS node 520 for the slot i. The calculation method of the transmission gain function of the RIS node 520 will be further described below.

In Equation 2, the parameter set A may be a set of values configured by the base station 510 to compensate for interference or path loss and signaled to the RIS node 520. The parameter set A may include M_{RB,f,c,n}(i), μ, P_{O_RIS,f,c,n}, and Δ_{TF,f,c,n}(i).

M_{RB,f,c,n}(i) included in the parameter set A may indicate the number of physical resource blocks (PRBs), which is the amount of frequency resources scheduled by the base station 520 for the slot i. μ included in the parameter set A may have one of the values exemplified in Table 1 as an SCS configuration value as described above. P_{O_RIS,f,c,n} included in the parameter set A may indicate the amount of interference measured by the base station and signaled to the RIS node 520. Finally, Δ_{TF,f,c,n}(i) included in the parameter set A may be a power offset according to a format or modulation and coding scheme (MCS) of data transmitted by the base station for the slot i.

The parameter set A of Equation 2 may be calculated based on the parameter set A of Equation 1 in the same manner as described above. As another example, the parameter set A of Equation 2 may be a specific form of values modified from the values of Equation 1. It should be noted that the notation of parameter set A in Equation 2 means that a specific value may be calculated based on the information included in the parameter set A.

Meanwhile, when the RIS node 520 is an active RIS reflector or a hybrid RIS reflector rather than a passive RIS reflector, the RIS node 520 may determine a transmission gain function g_{f,c,n} (i, k, l). Hereinafter, methods for the RIS node 520 to determine a transmission gain function based on control information received from the base station will be described.

### [Transmission Gain Determination Method 1]

If the connection between the base station 510 and the RIS node 520 is a wireless connection, the base station 510 may set an RIS transmission gain value to the RIS node 520 using physical layer signaling, for example, PDCCH. If the connection between the base station 510 and the RIS node 520 is a wired connection, the base station 510 may set an RIS transmission gain through a dedicated line connected to the RIS node 520. The following description will assume that the connection between the base station 510 and the RIS node 520 is a wireless connection.

The base station 510 may set the RIS transmission gain to the RIS node 520 using physical layer signaling, such as PDCCH. The RIS node 520 may calculate the transmission gain function g_{f,c,n} (i, k, l) based on the RIS transmission gain set by the base station 510 as in Equation 3 below.

$${g}_{f , c , n} ( i , k , l ) = {g}_{f , c , n} ( i - 1 , k , l ) + {δ}_{n} ( i - K ) \qquad [ Equation 3 ]$$

In Equation 3, g_{f,c,n}(i, k, l) may be a transmission gain state function value in the slot i−1, which is a slot immediately preceding the slot i for which the transmission gain is determined, and δₙ(i−K) may be a correction value received from the base station, which means a correction value that changes according to a control command included in a downlink control channel in a slot before K slots from the slot i for which the transmission gain is determined. Therefore, the base station 510 may provide the correction value to the RIS node 520 through physical layer signaling. As can be seen from Equation 3, the transmission gain state function may be calculated by accumulating the transmission gain function of the previous slot for each slot.

The transmission gain determination method 1 may be a suitable method when dynamically determining the optimal gain. As an example to which the transmission gain determination method 1 is applicable, it may be suitable when dynamically determining the transmission gain for a specific terminal or dynamically determining the transmission gain for each terminal group. Another example to which the transmission gain determination method 1 is applicable may be a case where the transmission gain is set for each base station or a case where the transmission gain is dynamically determined for each uplink, downlink, and RIS phase shift design. A transmission gain state function corresponding to each of these cases may be defined. In addition, in some cases, a transmission gain state function may be configured to be commonly applied to several cases.

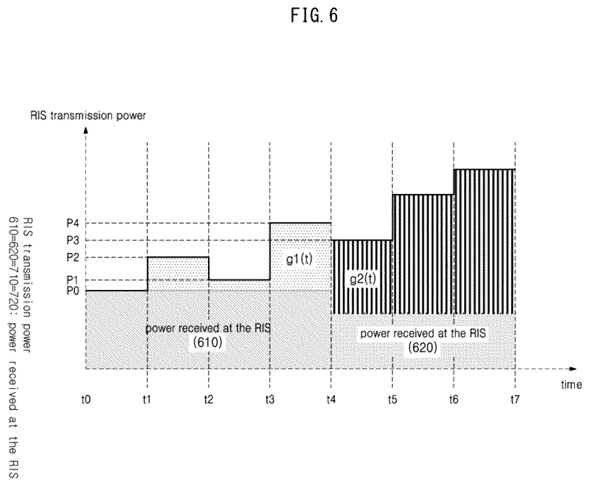

FIG. 6 is a transmission power graph according to an exemplary embodiment of a case where an RIS node transmits a received signal by amplifying the signal.

Referring to FIG. 6, the horizontal axis represents the time domain, and the vertical axis represents a RIS transmission power value. In description with reference to FIG. 6, for convenience of description, a downlink channel from the base station 510 to the terminal 530 may be considered. However, it should be noted that the following description may be equally applied even in the case of an uplink channel from the terminal 530 to the base station 510. In addition, for convenience of description, FIG. 6 may be an RIS transmission power graph assuming that the parameter set A of Equation 2 described above is not applied.

The powers 610 and 620 received at the RIS, which are exemplified in FIG. 6, may mean the reception power parameter Received Powerₙ(i) described in Equation 2. The reception power parameter Received Powerₙ(i) may be a value directly measured (or estimated) by the RIS node 520 as described above, or may be a value provided from the base station 510 to the RIS node 520. In the case where the base station 510 provides the reception power parameter Received Powerₙ(i) to the RIS node 520, Received Powerₙ(i) may be a reception power value that the base station expects at the RIS node 520.

In the example of FIG. 6, it is assumed that the power 610 received at the RIS node 520 has the same value from a time t0 to a time t4, and it is assumed that the power 620 received at the RIS node 520 has the same value from the time t4 to a time t7. However, a reception power at the RIS node 520 may vary at each time point. In addition, it is assumed that the power 610 received at the RIS node 520 from the time t0 to time t4 is different from the power 620 received at the RIS node 520 from the time t4 to time t7. In addition, a time interval from the time t0 to time t1 may be, for example, one slot. Therefore, each time interval of t0-t1, t1-t2, t2-t3, t3-t4, t4-t5, t5-t6, and t6-t7 may have one slot length. As another example, each time interval of t0-t1, t1-t2, t2-t3, t3-t4, t4-t5, t5-t6, and t6-t7 may be a time interval unit wherein transmission is performed based on one power control command. In other words, it may be an update time unit of Equation 3.

At the time to, the RIS node 520 may perform power amplification of the signal received during the interval t0-t1 based on the power 610 received at the RIS. Since the power amplification at the time to is in a state where there is no transmission gain specifically determined at the previous time, the power gain value exemplified in Equation 3 may not be compensated. At the time to, only a transmission gain state function g_{f,c,n}(t0, k, l) is applied to the transmission gain, and the correction value &n is not applied. When the transmission gain state function g_{f,c,n} (t0, k, l) has a zero value, the RIS node 520 may reflect incident signals with a power P0 determined based on the received power 610. In other words, the RIS node 520 may amplify the signal received from the base station 510 to have the power P0 and transmit it to the terminal 530.

At the time t1, the RIS node 520 may determine a transmission gain using the power 610 received at the RIS and the P0 value, which is the power amplification value from the time t0 to time t1. In this case, since the transmission power from the time t0 to time t1 exists, a transmission gain state function g_{f,c,n}(t1, k, l) may be a value changed by on from g_{f,c,n}(t0, k, l). According to the example of FIG. 6, the transmission gain of the RIS node 520 may be determined so that the power value is determined to be P2 based on the transmission gain state function g_{f,c,n}(t1, k, l). Accordingly, the RIS node 520 may reflect an incident signal by amplifying the incident signal with a value determined by the transmission gain state function g_{f,c,n}(t1, k, l). In other words, the RIS node 520 may amplify the signal received from the base station 510 to have the power P2 and transmit it to the terminal 530.

At the time t2, the RIS node 520 may determine a transmission gain using the power 610 received at the RIS and the P2 value, which is the power amplification value from the time t1 to time t2. In the same manner as described above, a transmission gain state function g_{f,c,n}(t2, k, l) at the time t2 may be a value changed by δₙ from the transmission gain state function g_{f,c,n}(t1, k, l) for the previous time. Therefore, as illustrated in FIG. 6, the RIS node 520 may reflect an incident signal with a power of P1 by amplifying the incident signal with a value determined by the transmission gain state function g_{f,c,n}(t2, k, l). In other words, the RIS node 520 may amplify the signal received from the base station 510 to have the power P1 and transmit it to the terminal 530. As a result, the power P1 may be a result of accumulating the transmission gains from the time t0 to time t2.

At the time t3, the RIS node 520 may determine a transmission gain based on the power 610 received at the RIS, the power amplification value P1 from the time t2 to time t3, and a transmission gain state function g_{f,c,n}(t3, k, l). According to the example illustrated in FIG. 6, the RIS node 520 may determine a power gain as a power P4 by the transmission gain state function g_{f,c,n}(t3, k, l). Accordingly, the RIS node 520 may reflect a received signal by amplifying the received signal by a value determined by the transmission gain state function g_{f,c,n} (t3, k, l). In other words, the RIS node 520 may amplify the signal received from the base station 510 to have the power P4 and transmit it to the terminal 530. The power P4 may be a result of accumulating the transmission gains from the time t0 to time t3.

The transmission gain functions used from the time t0 to time t4 may be, for example, values applied to a first terminal. After the time t4, signals may be transmitted to a second terminal instead of the first terminal. When signals are transmitted to the second terminal, the RIS node 520 may use a new transmission gain function. In FIG. 6, the transmission gain function applied to the first terminal is exemplified as g1(t), and the transmission gain function applied to the second terminal is exemplified as g2(t).

At the time t4, the RIS node 520 may determine P3 as a power amplification value used for transmission from the base station 510 to the second terminal based on the power 620 received at the RIS and the new transmission gain function g2(t). Accordingly, the RIS node 520 may reflect a received signal by amplifying the received signal with the P3 value. In other words, the RIS node 520 may amplify the signal received from the base station 510 to have the power value of P3 and transmit it to the second terminal.

Since the method for determining transmission power after the time t5 is the same as described above, redundant description will be omitted.

Meanwhile, in description with reference to FIG. 6, it is assumed that signals are transmitted to the first terminal before the time t4, and signals are transmitted to the second terminal after the time t4. However, the first terminal may be understood as being replaced with a specific terminal group, and the second terminal may be understood as being replaced with another terminal group. As another example, signal transmission before the time t4 may mean a downlink channel, and signal transmission after the time t4 may mean an uplink channel.

Another example may be a case where a phase shift design of the RIS node 520 is changed. For example, if a phase shift design k of the RIS node 520 is used before the time t4, but a phase shift design k′ of the RIS node 520 is used the after time t4, the transmission gain function may be changed as shown in FIG. 6. If the phase shift design of the RIS node 520 is changed, transmissions for the same terminal, the same group, or the same channel (e.g. the same downlink channel or the same uplink channel) may be performed before and after the time t4.

If the phase shift design is changed and the transmission gain function is changed, the previous transmission power value may be continuously accumulated and applied.

### [Transmission Gain Determination Method 2]

If a phase shift design of the terminal, terminal group, base station, uplink, downlink, or RIS supported by the RIS node 520 is changed, the RIS node 520 may initialize calculation of the power control function exemplified in Equation 2. When initializing calculation of the power control function, g_{f,c,n}(i−1, k, l) exemplified in Equation 3 may be initialized to zero. Therefore, a transmission gain may be determined based on the power determination method at the time to described in FIG. 6 above.

The transmission gain determination method 2 according to the present disclosure may be suitable when the RIS node 520 has a large difference in channel environment due to a change in the terminal, terminal group, base station, uplink, downlink, or RIS phase shift design whose signals are reflected.

If the terminal, terminal group, base station, uplink, downlink, or RIS phase shift design supported by the RIS node 520 is not changed, the power control state function value described above may be calculated in the same manner as described in the transmission gain determination method 1.

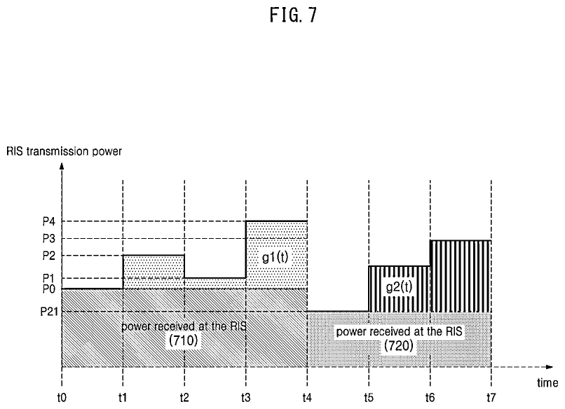

FIG. 7 is a transmission power graph according to another exemplary embodiment of a case where an RIS node transmits a received signal by amplifying the signal.

Referring to FIG. 7, the horizontal axis represents the time domain, and the vertical axis represents a RIS transmission power value. In description with reference to FIG. 7, for convenience of description, a downlink channel from the base station 510 to the terminal 530 may be considered. However, it should be noted that the following description may be equally applied even in the case of an uplink channel from the terminal 530 to the base station 510. In addition, for convenience of description, FIG. 7 may be an RIS transmission power graph assuming that the parameter set A of Equation 2 described above is not applied.

The operation of the RIS node 520 from a time t0 to a time t4 may be the same as described in FIG. 6. Therefore, redundant description will be omitted. At the time t4, a terminal, terminal group, base station, uplink, downlink, or phase shift design supported by the RIS node 520 may be changed. Therefore, the RIS node 520 may change a transmission gain state function for transmission gain calculation after the time t4. As described in the transmission gain determination method 2, when the phase shift design of the RIS is changed, the RIS node 520 may initialize calculation of the power control function. Initializing calculation of the power control function may mean determining the power control function value of Equation 3 as a zero value.

From the time t4 to time t5, for signal transmission, the RIS node 520 may perform power amplification of a received signal based on a power 710 received at the RIS. Since the power amplification at the time t4 is the first time signals are reflected after initializing the power control function, it may be assumed that there is no transmission gain specifically determined at the previous time. Therefore, the power gain value exemplified in Equation 3 may not be corrected. At the time t4, a transmission gain state function may be applied as a zero value, and a correction value δₙ may not be applied. Accordingly, the RIS node 520 may reflect an incident signal with a power value of P21 determined based on the received power 720. In other words, the RIS node 520 may amplify the signal received from the base station 510 to have the power P21 and transmit it to the terminal 530.

At the time t5, the RIS node 520 may determine a transmission gain by using a power 720 received at the RIS and the P21 value, which is the power amplification value from the time t4 to time t5. In this case, since the transmission power from the time t4 to time t5 exists, a transmission gain state function g_{f,c,n}(t5, k, l) may be a value changed by δₙ from g_{f,c,n}(t4, k, l). According to the example of FIG. 7, the transmission gain of the RIS node 520 may be determined to be P21 based on the transmission gain state function g_{f,c,n}(t5, k, l). Accordingly, the RIS node 520 may reflect an incident signal by amplifying the incident signal by a value determined by the transmission gain state function g_{f,c,n} (t5, k, l). In other words, the RIS node 520 may amplify the signal received from the base station 510 to have the power P2 and transmit it to the terminal 530.

The difference in FIG. 7 compared to FIG. 6 is that the transmission gain function is changed due to the change in the phase shift design of the RIS node 520. The transmission gain after the time t6 may determine in the same manner as described above in FIG. 6.

### [Transmission Gain Determination Method 3]

According to the transmission gain determination method 3, the base station 510 may determine whether to initialize the previous transmission gain state function value at a specific time or to continue to accumulate and determine the transmission gains. Then, the base station 510 may notify the RIS node 520 of information on whether to initialize the transmission gain state function. The operation of the RIS node 520 according to the transmission gain determination method 3 may be performed using Equation 4.

$${g}_{f , c , n} ( i , k , l ) = γ \cdot {g}_{f , c , n} ( i - 1 , k , l ) + {δ}_{n} ( i - K ) \qquad [ Equation 4 ]$$

Equation 4 may have a form that has an additional weighting factor γ when compared to Equation 3 described above. In other words, Equation 3 may be a specific example of Equation 4. In other words, Equation 3 may be a special case in which the weighting factor is 1. In addition, the operation of initializing the transmission gain state function to 0 in the transmission gain determination method 2 described above may be a special case in which the weighting factor is 0.

The base station 510 may determine the weighting factor and provide it to the RIS node 520 through a downlink control channel. In this case, the weighting factor may have a value as 0≤γ≤1.

### [Transmission Gain Determination Method 4]

The transmission gain determination methods 1 to 3 described above are methods for dynamically changing the transmission gain through a downlink control channel. The transmission gain determination method 4 according to the present disclosure may utilize high layer signaling, for example, radio resource control (RRC) signaling and/or medium access control (MAC)-control element (CE) signaling. Accordingly, the transmission gain may be determined statically or semi-statically, in contrast to the methods using a downlink control channel.

Therefore, the transmission gain determination method 4 differs only in that it uses RRC signaling and/or MAC-CE signaling, and all of the transmission gain determination methods 1 to 3 may be applied. When using the higher layer signaling as described above, unnecessary signaling overhead between the base station 510 and the RIS node 520 may be reduced. Alternatively, the base station 510 may provide the RIS node 520 with information such as the transmission gain state functions and/or the transmission gain state functions to be used through the higher layer signaling, and may transmit only specific information that requires dynamic change, for example, the correction value δₙ(i−K) of Equation 3 or Equation 4, or may dynamically change the weight factor γ in Equation 4 by using a downlink control channel.

The above-described transmission gain determination methods for amplifying a transmission power of data may be applied when the terminal or another RIS node controls the RIS node. Therefore, the RIS node 520 that amplifies a transmission power of data may configure a transmission gain based on physical layer signaling or higher layer signaling signal transmitted by the terminal or another RIS node. In addition, it is also possible to combine the higher layer signaling signal and the physical layer signaling signal as described in the transmission gain determination method 4.

### Second Exemplary Embodiment

In the second exemplary embodiment, methods for setting a transmission gain for amplifying a transmission power of data according to a situation will be described for a case where the RIS node 520 receives data transmitted by the base station 510 or the terminal 530 and transmits the data by power-amplifying and phase-changing the data. The transmission gain described in the second exemplary embodiment below may mean the transmission gain based on Equations 2 and 3, or the transmission gain based on Equation 2 and 4 described in the first exemplary embodiment.

### [Situation-Specific Transmission Gain Setting Method 1]

The time division duplex (TDD) scheme used in the LTE system and the LTE-A system is also used in the 5G communication system. Therefore, the base station 510 may set uplink and downlink gains differently according to a TDD configuration. For example, if the uplink gain is g_{UL} and the downlink gain is g_{DL}, g_{UL} and g_{DL} may have different values. When determining g_{UL} and g_{DL}, the base station 510 may set g_{UL} to be higher than g_{DL} in order to reduce power consumption of the terminal 530. This is because a transmission power limit of the terminal 530 using battery may be smaller than a transmission power limit of the base station 510.

### [Situation-Specific Transmission Gain Setting Method 2]

When determining the transmission gain of the RIS node 520, the base station 510 may set a transmission gain differently for each terminal or terminal group. If a transmission gain is set differently for each terminal, a distance, channel environment, obstacles, etc. between the terminal 530 and the base station 510 may be considered. For example, it may be assumed that a distance between a first terminal from the base station 510 through the RIS node 520 is R1, and a distance between a second terminal from the base station 510 through the RIS node 520 is R2. In this case, it may be assumed that R1 is smaller than R2. In addition, it may be assumed that a transmission gain of the first terminal that the base station 510 sets for the RIS node 520 is gUE1, and a transmission gain of the second terminal that the base station 510 sets for the RIS node 520 is gUE2. Then, the RIS node 520 may receive a signal to be transmitted from the base station 510 to the first terminal, amplify the signal to have a transmission gain of gUE1, and then transmit it to the first terminal. In addition, the RIS node 520 may receive a signal to be transmitted from the base station 510 to the second terminal, amplify the signal to have a transmission gain of gUE2, and then transmit it to the second terminal. In this case, gUE2 may be a greater transmission gain than gUE1.

As described above, the fact that the amplification gain varies between gUE1 and gUE2 based on R1 and R2 may be due to the installation of the RIS node 520. In general, the base station 510 may be designed to have a specific coverage. However, since the RIS node 520 is installed to extend the coverage of the base station 510, a distance difference between R1 and R2 may generally be greater than a distance between terminals located within the coverage of the base station 510. Therefore, it may be preferable for the base station 510 to consider not only the distance between the base station 510 and the RIS node 520 but also the distance between the RIS node 520 and the terminal. Based on the distance between the base station 510 and the RIS node 520, the base station 510 may determine the transmission power of the signal to be transmitted to the terminal, and may determine the amplification gain of the RIS node 520 by considering the transmission power of the base station 510 and the distance from the RIS node 520 to the terminal.

### [Situation-Specific Transmission Gain Setting Method 3]

Multiple base stations may provide services to different terminals through one RIS node. For example, when a first base station transmits and/or receives data to a first terminal, a first RIS node may be used. In addition, when a second base station transmits and/or receives data to a second terminal, the first RIS node may be used. In other words, one RIS node may receive signals from multiple base stations, amplify them, and then transmit (reflect) the signals to terminals to which the base station intends to transmit.

As briefly described above, the installation conditions of the RIS node may be different from the installation conditions of the base station. In other words, the RIS node may be deployed so as to improve coverages of multiple base stations without improving a coverage of only one specific base station. In this case, the RIS node may set a transmission gain differently for each base station.

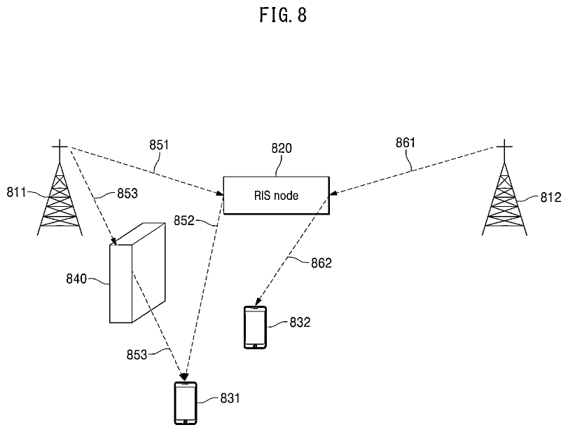

FIG. 8 is a conceptual diagram for describing a case where multiple base stations transmit signals to terminals through one RIS node.

Referring to FIG. 8, a first base station 811 and a second base station 812 are illustrated as an example. In addition, the first base station 811 may transmit a signal to a first terminal 831 through an RIS node 820, and a second base station 812 may transmit a signal to a second terminal 832 through the RIS node 820. In other words, the first base station 811 and the second base station 812 may share the same RIS node 820, and may transmit signals to the terminals they each serve through the RIS node 820. The base stations 811 and 812 and the terminals 831 and 832 illustrated in FIG. 8 may have the same configuration as the base station 510 and the terminal 530 described with reference to FIG. 5.

In the example of FIG. 8, only a downlink channel is illustrated for convenience of description, and description will be made using the downlink channel. However, it should be noted that the description may be applied to an uplink channel in the same manner.

When the first base station 811 wishes to transmit data to the first terminal 831, if there is an obstacle 840, the data may be transmitted using the RIS node 820. In other words, if there is no obstacle, the data may be transmitted to the first terminal 831 through downlink channels 853 and 854 indicated by dotted lines. However, if the first base station 811 cannot directly transmit data to the first terminal 831 due to the obstacle 840, the first base station 811 may transmit the data to the first terminal 831 through a downlink channel 851 to the RIS node 820 and a reflected downlink channel 852 that has undergone amplification and phase shift at the RIS node 820.

Therefore, transmission of the data between the first base station 811 and the first terminal 831 may correspond to a detour route.

Meanwhile, the second base station 812 may be located at a distance where it cannot directly transmit a downlink channel to the second terminal 832. In other words, a signal transmitted by the second base station 812 may not be delivered to the second terminal 832 due to attenuation of the signal. This may correspond to a case where severe attenuation of signals occurs due to a high frequency in the case of a frequency range 2 (FR2) of the 5G system or in the case of a 6G communication system that is developed to communicate in a higher band in the future. Therefore, the second base station 812 may transmit data to the second terminal 832 through a downlink channel 861 to the RIS node 820 and a downlink channel 862 that is reflected by performing amplification and phase shift at the RIS node 820.

As described above, in the downlink channels 851 and 852 from the first base station 811 to the first terminal 831 and the downlink channels 861 and 862 from the second base station 812 to the second terminal 832, the RIS node 820 may be used for different reasons. Accordingly, a distance R1 from the first base station 811 to the first terminal 831 through the RIS node 820 may be different from a distance R2 from the second base station 812 to the second terminal 832 through the RIS node 820.

As described above, a transmission gain of the RIS node may vary based on the distances from the base stations to the terminals and the distances from the RIS node to the terminals. In other words, the first base station 811 may set the transmission gain of the RIS node 820 to be small when transmitting data to the first terminal 831, and the second base station 812 may set the transmission gain of the RIS node 820 to be large when transmitting data to the second terminal 832.

In other words, each of the base stations may determine the transmission gain of the RIS node based on the distance between the base station and the terminal as well as the distance between the RIS node and the terminal.

### [Situation-Specific Transmission Gain Setting Method 4]

As described in the first exemplary embodiment, the transmission gain may vary depending on the phase shift design of the RIS node. Therefore, the base station may set the transmission gain differently for each phase shift design. In this case, when a basic transmission gain is set for each phase shift design or if a transmission gain that can be used for each phase shift design is preconfigured, the base station may provide it to the RIS node in advance through higher layer signaling. A mapping between transmission gain functions that can be used for each phase shift design may be exemplified as in Table 2 below.

TABLE 2

| | Transmission gain functions |
|---|---|
| phase shift design index | that can be used |
| phase shift design index #1 | Transmission gain function 1-1 |
| | Transmission gain function 1-2 |
| phase shift design index #2 | Transmission gain function 1-1 |
| | Transmission gain function 2-1 |
| | Transmission gain function 2-2 |
| . . . | . . . |
| phase shift design index #m | Transmission gain function k |

As exemplified in Table 2, there may be one or more transmission gain functions that can be used for each phase shift design index. For example, a phase shift design index #1 may correspond to a case where a transmission gain function 1-1 and a transmission gain function 1-2 can be used, a phase shift design index #2 may correspond to a case where the transmission gain function 1-1, transmission gain function 2-1, and transmission gain function 2-2 can be used, and a phase shift design index #m may correspond to a case where only a transmission gain function k can be used.

As exemplified in Table 2, one phase shift design may be able to use two or more transmission gain functions, and one phase shift design may be able to use only one transmission gain function. In addition, there may be a case where a transmission gain function (e.g. transmission gain function 1-1) is used for both the phase shift design index #1 and phase shift design index #2.

It should be noted that Table 2 is merely an example to help understanding of the present disclosure, and may be used in a more expanded or reduced form.

As shown in Table 2, since the relationship between phase shift and amplification gain exists from hardware perspective, the amplification gain may also have a difference depending on the phase shift.

The methods of the second exemplary embodiment described above may be a method of setting a transmission gain for amplifying a transmission power of data, and a case where a transmission gain is set by the base station has been described. However, as described in the first exemplary embodiment, the transmission gain of the RIS node may be set by the terminal or another RIS node. In addition, as described in the first exemplary embodiment, it should be noted that only physical layer signaling or only higher layer signaling may be used, or physical layer signaling and higher layer signaling may be used together.

### Third Exemplary Embodiment

In the third exemplary embodiment described below, methods for setting a gain according to a range in which a transmission gain for amplifying a transmission power of data in the RIS node is applied will be described for a case where the RIS node receives data transmitted by a base station or terminal and transmits the data by power-amplifying and/or phase-shifting the data. The transmission gain described in the third exemplary embodiment below may mean the transmission gain based on Equations 2 and 3 or the transmission gain based on Equations 2 and 4 described in the first exemplary embodiment.

### [Range-Specific Transmission Gain Setting Method 1]

In the following description, the RIS node 520 will described with reference to the previously described FIG. 5. In addition, as previously described, description will be made assuming that the base station 510 performs control of the amplification gain and/or phase shift of the RIS node 520. However, the control of the amplification gain and/or phase shift of the RIS node 520 may be performed by another RIS node or terminal 530 as previously described.

The RIS reflector 522 of the RIS node 520 may be composed of a plurality of reflecting elements. Each of the reflecting elements may be configured as an element capable of reflecting incident radio waves by power-amplifying and/or phase-shifting the received radio waves. Accordingly, each of the reflecting elements constituting the RIS reflector 522 may have a transmission gain set therefor. When a separate transmission gain is set for each reflecting element as described above, power amplification and/or phase shift of a reflected signal (i.e. received signal) may be performed, thereby maximizing the performance and efficiency of transmission of the signal. In order to set the transmission gain differently for each reflecting element, a transmission gain value needs to be set for each reflecting element, and thus the base station 510 needs to transmit a large amount of control information to the RIS node 520 in order to control the transmission gains for the respective reflecting elements. In order to transmit such a large amount of control information, it is difficult to use physical layer signaling, so it may be preferable to transmit the control information through higher layer signaling.

When the terminal 530 controls the RIS node 520, a control signal may control each of the reflecting elements constituting the RIS reflector 522 of the RIS node 520 through a signal in the form of data. As the number of reflecting elements of the RIS node 520 increases, a larger amount of control information is required, so the overhead increases when the base station 510 or the terminal 530 controls the reflecting elements. As a method to reduce this overhead, only ON/OFF of each reflecting element of the RIS node 520 may be configured. When only ON/OFF of each reflecting element constituting the RIS reflector 522 of the RIS node 520 is configured, only one bit is required for each reflecting element, so that the overhead can be reduced. If the number of reflecting elements constituting the RIS reflector 522 is small, the base station, terminal, or another RIS node controlling the amplification gain and/or phase shift of the RIS node 520 may transmit control information through physical layer signaling.

### [Range-Specific Transmission Gain Setting Method 2]

In the range-specific transmission gain setting method 1 described above, the number of bits to be transmitted may vary depending on the number of reflecting elements constituting the RIS reflector 522 of the RIS node 520. In particular, if the RIS reflector 522 of the RIS node 520 has a large number of reflecting elements, a large amount of overhead is required.

In the range-specific transmission gain setting method 2 of the present disclosure, a transmission gain of a large number of reflecting elements constituting the RIS reflector 522 of the RIS node 520 may set in cluster units in order to reduce overhead. The reflecting elements of the RIS reflector 522 may be configured in a form having n rows and m columns, as illustrated in FIG. 5. Therefore, the base station 510 controlling the RIS node 520 may indicate clustering of the reflecting elements of the RIS node 520 through higher layer signaling. When clustering a predetermined number of reflecting elements, the number of clusters may be determined. In addition, a structure of reflecting elements may be determined for each cluster. For example, only the even-numbered (or odd-numbered) reflecting elements of each column (or each row) may form one cluster. As another example, one or more predetermined row(s) may form one cluster. As another example, several reflecting elements (the positions of the reflecting elements may be specified) in a specific row and several reflecting elements (the positions of the reflecting elements may be specified) in a specific column may be formed into one cluster.

When clusters are configured as above, the base station 510 may control the respective elements of the corresponding clusters by transmitting physical layer signaling information that sets values for transmission gains and/or phase shifts to the RIS node 520. In this case, as a method for further reducing the amount of information, values for the transmission gains and/or phase shifts for each cluster may configured in advance as a specific table, a setting value indicating specific entry(ies) of the table may be transmitted to the RIS node 520.

### [Range-Specific Transmission Gain Setting Method 3]

The amplification gain of the RIS node 520 may be set as a single value. In other words, the total transmission power of the RIS reflector 522 of the RIS node 520 may be determined without setting a transmission gain of each of the reflecting elements of the RIS node 520. In this case, the determining of the total transmission power of the RIS reflector 522 may have the same meaning as determining a transmission gain of the RIS node 520. If a power gain value of the RIS node 520 is 1, it may mean that there is no amplification, if the power gain value thereof is 1.2, it may mean that an input signal is transmitted with a power gain of 20%, and if the power gain value is 1.5, it may mean that an input signal is transmitted with a power gain of 50%.

When determining the power gain of the RIS node 520 as described above, two or more resolutions may be used as exemplified above. When there are two or more resolutions, there is an advantage in that the transmission gain can be precisely controlled for each transmitted signal (or data).

The above three methods described in the third exemplary embodiment are methods for setting the transmission gain for amplifying a transmission power of data, and as described above, the RIS node may be controlled not only by the base station but also by another RIS node or the terminal. In addition, as described above, higher layer signaling and/or physical layer signaling may be used depending on the amount of control information to be provided.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a reflecting node, comprising:
receiving, from a first node, power control information that sets an amplification amount of a first signal transmitted from the first node to a second node in an n-th slot, n being a natural number;
amplifying the first signal received from the first node based on the power control information; and
reflecting the amplified first signal to the second node,
wherein the power control information includes information on a mode of a reflector included in the reflecting node, a maximum transmission power of the reflecting node, a signal power expected to be received at reflecting elements of the reflecting node, a first transmission gain function, and a first parameter set.

2. The method according to claim 1, wherein the first parameter set includes at least one of: a number of physical resource blocks (PRBs) in which the first signal is transmitted, subcarrier spacing (SCS) information, interference information measured by the first node, or a power offset according to a modulation and coding scheme (MCS) of the first signal.

3. The method according to claim 1, wherein when the first node is a base station, the second node is a user equipment (UE), and the first node and the reflecting node are wirelessly connected, the power control information is transmitted through a physical downlink control channel (PDCCH) or high layer signaling.

4. The method according to claim 1, wherein the first transmission gain function is determined based on a sum of a first transmission gain value determined by multiplying a second transmission gain state function value determined in an (n−1)-th slot with a weight factor received from the first node and a correction value received from the first node.

5. The method according to claim 4, wherein when the first signal is an initial transmission signal, the weight factor has a zero value.

6. The method according to claim 1, wherein when a time division duplex (TDD) configuration is used between the first node and the second node, the first transmission gain function is configured for each of a power gain from the first node to the second node and a power gain from the second node to the first node.

7. The method according to claim 1, wherein the first transmission gain function varies depending on a phase shift design, and one or more transmission gain functions are available for one phase shift design.

8. The method according to claim 1, wherein the first transmission gain function is configured for at least one of each reflecting element included in the reflecting node, each of cluster(s) composed of multiple reflecting elements, or all of the reflecting elements of the reflecting node, and the cluster(s) are configured in advance by the first node.

9. A method of a base station, comprising:
transmitting, to a reflecting node, power control information that sets an amplification amount of a first signal to be transmitted to a terminal in an n-th slot, n being a natural number; and
transmitting the first signal to the reflecting node at a preset power,
wherein the power control information includes information on a mode of a reflector included in the reflecting node, a maximum transmission power of the reflecting node, a signal power expected to be received at reflecting elements of the reflecting node, a first transmission gain function, and a first parameter set.

10. The method according to claim 9, wherein the first parameter set includes at least one of: a number of physical resource blocks (PRBs) in which the first signal is transmitted, subcarrier spacing (SCS) information, interference information measured by the first node, or a power offset according to a modulation and coding scheme (MCS) of the first signal.

11. The method according to claim 9, wherein the first transmission gain function is determined based on a sum of a first transmission gain value determined by multiplying a second transmission gain state function value determined in an (n−1)-th slot with a weight factor received from the first node and a correction value received from the first node.

12. The method according to claim 11, wherein when the first signal is an initial transmission signal, the weight factor has a zero value.

13. The method according to claim 9, wherein when a time division duplex (TDD) configuration is used between the first node and the second node, the first transmission gain function is configured for each of an uplink power gain and a downlink power gain.

14. The method according to claim 9, wherein the first transmission gain function varies depending on a phase shift design, and one or more transmission gain functions are available for one phase shift design.

15. The method according to claim 9, wherein the first transmission gain function is configured for at least one of each reflecting element included in the reflecting node, each of cluster(s) composed of multiple reflecting elements, or all of the reflecting elements of the reflecting node, and the cluster(s) are configured in advance by the first node.

16. A reflecting node comprising:
a reconfigurable intelligent surface (RIS) reflector including a plurality of reflecting elements; and
at least one processor for controlling the RIS reflector,
wherein at least one processor causes the reflecting node to perform:
receiving, from a first node, power control information that sets an amplification amount of a first signal transmitted from the first node to a second node in an n-th slot, n being a natural number;
amplifying the first signal received from the first node based on the power control information; and
reflecting the amplified first signal to the second node,
wherein the power control information includes information on a mode of a reflector included in the reflecting node, a maximum transmission power of the reflecting node, a signal power expected to be received at reflecting elements of the reflecting node, a first transmission gain function, and a first parameter set.

17. The reflecting node according to claim 16, wherein the first parameter set includes at least one of: a number of physical resource blocks (PRBs) in which the first signal is transmitted, subcarrier spacing (SCS) information, interference information measured by the first node, or a power offset according to a modulation and coding scheme (MCS) of the first signal.

18. The reflecting node according to claim 16, wherein when the first node is a base station, the second node is a user equipment (UE), and the first node and the reflecting node are wirelessly connected, the power control information is transmitted through a physical downlink control channel (PDCCH) or high layer signaling.

19. The reflecting node according to claim 16, wherein the first transmission gain function is determined based on a sum of a first transmission gain value determined by multiplying a second transmission gain state function value determined in an (n−1)-th slot with a weight factor received from the first node and a correction value received from the first node, and when the first signal is an initial transmission signal, the weight factor has a zero value.

20. The reflecting node according to claim 16, wherein the first transmission gain function varies depending on a phase shift design, and one or more transmission gain functions are available for one phase shift design.
